(19) United States
(12) Patent Application Publication
(10) Pub. No.: US 2008/0256725 A1
(43) Pub. Date: Oct. 23, 2008

(54) Method for Colouring Toothbrush Filaments

(76) Inventor: Thorsten Emge, Rodgau (DE)

Correspondence Address: FISH & RICHARDSON PC, P.O. BOX 1022, MINNEAPOLIS, MN, 55440-1022, US

(21) Appl. No.: 12/067,695

(22) PCT Filed: Sep. 12, 2006
(86) PCT No.: PCT/EP06/08841

§ 371 Date: Apr. 11, 2008

(30) Foreign Application Priority Data
Sep. 23, 2005 (DE) 10 2005 045 501.8

(51) Int. Cl. D06P 1/00; B05D 3/00; A46D 1/04

(52) U.S. Cl. 8/506; 427/2.29; 15/207.2

(57) ABSTRACT

A method of applying a consumable, in particular a wear indicator dye, to toothbrush filaments and/or other wearing parts for personal needs, in which the consumable is added to a medium which is subjected to pressure above atmospheric, and the toothbrush filaments and/or the wearing part are exposed to the pressurized mixture of consumable and medium for a predetermined exposure period. The medium to which the consumable is added includes CO₂ as an essential constituent. The mixture of consumable and CO₂ can be circulated in a pressure vessel under high pressure, so that the mixture is caused to flow around the toothbrush filaments or the corresponding wearing part.

### TECHNICAL FIELD

This invention relates to a method of applying a wear indicator dye or some other consumable to toothbrush filaments and/or other wearing parts for personal needs.

### BACKGROUND

In toothbrush bristles it is known to use a wear indicator in the form of a colored region which undergoes a color change in response to increased use or wear. To accomplish this, a dye is diffused into the outer layer of the monofilaments, the dye gradually volatilizing through use of the toothbrush, so that the toothbrush filaments lose their dye over time and re-adopt their original color, thereby enabling the user to detect the condition of wear of his or her toothbrush. Hitherto practice has been to apply the wear indicator dye to the toothbrush filaments by an immersion process. In this regard, U.S. Pat. No. 4,802,255 and EP 0 303 202 B1 propose adding a suitable food colorant, for example, erythrosine, to an aqueous solution with a defined pH, bringing the dye solution to boiling and immersing the filaments into the boiling dye solution for 60 minutes. To achieve an increased degree of dye penetration, the documents cited propose subjecting the dye solution with the filaments therein immersed to pressure above atmospheric in a pressure vessel.

While these known immersion techniques for dyeing toothbrush filaments are used on a large industrial scale with great success, they exhibit nevertheless some problematic aspects. In particular the high dyeing temperatures may affect the filament properties undesirably. In addition, they use acetic acid which requires neutralization and intensive washing of the filaments after the dyeing process.

### SUMMARY

An improved method of applying a wear indicator dye or some other consumable to a portion of a dental care device is featured. The dental care device is, for example, a toothbrush. The indicator dye can be applied to toothbrush filaments, a portion of a toothbrush head, a portion of a toothbrush handle, or other wearing parts for personal needs. In one aspect, applying the consumable to the toothbrush filaments or the corresponding wearing part for personal needs includes employing CO₂ under high pressure. The medium to which the consumable to be applied is added and which is subjected to pressure above atmospheric includes CO₂ as an essential constituent. In some implementations, the medium may consist of CO₂ substantially completely, or consist essentially of CO₂. The consumable is impregnated with CO₂ under pressure, and the toothbrush filaments are passed into the resultant mixture of consumable and CO₂ in order to thereby apply the consumable to the toothbrush filaments. When the toothbrush filaments are exposed to the high-pressure mixture of consumable and CO₂, the consumable is able to diffuse into the outer layers of the filaments.

Where appropriate, the consumable may be first dissolved in water before it is passed into CO₂. In an advantageous embodiment, the consumable may be dissolved in water to 0.005% to 0.5%, preferably to about 0.05% to 0.3% before the solution thereby obtained is impregnated with CO₂ under pressure. Alternatively, the consumables may also be impregnated with CO₂ entirely without the addition of water, in particular when water-insoluble consumables are used.

Advantageously, the consumable can be applied without separating the individual toothbrush filaments. In one implementation, whole filament strands, referred to as hanks, and/or filament spools are exposed to the mixture of consumable and CO₂. The use of CO₂ enables the consumable to dye or penetrate the filaments uniformly also without the need to separate the individual filaments. In this process, several tens of thousands of individual filaments may be combined into one filament strand, i.e., one hank. For toothbrushes, hanks of a length of 1 m-2 m and a diameter of 30 mm to 70 mm and including around 30,000 to 80,000 individual filaments may be used. The hanks are exposed to the mixture of consumable and CO₂ simultaneously when the whole hank is passed into the device. Alternatively, it is also possible for filaments to be dyed on spools onto which filaments tens of thousands of meters in length can be wound. In this case spools are preferably used which have a permeable spool core and/or permeable flanges or end walls, thereby enabling the mixture of consumable and CO₂ to circulate through the walls of the spool body.

Simultaneous treatment of a plurality of toothbrush filaments combined to form a hank and/or wound onto a spool simplifies handling of the filaments during the process. In particular the need to transfer the filaments separately is obviated, which is a highly complicated procedure in conventional methods.

In order to apply the consumable more uniformly and achieve a better degree of penetration of the hanks or wound layers, an advantageous embodiment of the invention provides for the pressurized mixture of consumable and CO₂ to be set in circulation, thereby causing the mixture to flow around the toothbrush filaments or the wearing part for personal needs. In this process in particular, the mixture may be circulated through a pressure vessel and/or a piping so that the consumable particles impregnated with CO₂ are brought into contact with the filaments again and again.

Advantageously, the toothbrush filaments or the corresponding wearing part to which the consumable is to be applied are exposed to the mixture in a pressure vessel in a discontinuous process. In lieu of a batch process, it would also be generally conceivable to apply the mixture of consumable and CO₂ to the filament hanks or spools in a continuous or semi-continuous process. The discontinuous process produces however superior dyeing or penetration results using simpler devices.

Regarding the process parameters for the application of the toothbrush filaments with the mixture of consumable and CO₂, various modifications and adaptations to the respective parts to be dyed are possible and suitable.

A preferred embodiment of the invention may include bringing the medium, which includes CO₂ as an essential constituent, into the supercritical state by subjecting it to a suitable pressure and/or temperature in order to apply the consumable to the toothbrush filaments. This makes it possible for both hank and spool material to take the dye particularly uniformly and to reach high degrees of penetration.

In respect of the temperature, the present method affords the advantage of distinguishing itself by the use of low temperatures. Generally, the process can be performed at room temperature, thereby substantially avoiding adverse effect on the filaments to be treated. However, exposure to temperatures of up to 140° C. is also possible. According to a preferred embodiment of the invention, the consumable-medium mixture to which the toothbrush filaments are exposed may be heated to temperatures of preferably 60° C. to 80° C., approximately. Compared to the conventional dyeing methods for toothbrush filaments, these temperatures are significantly lower, so that undesired impairment of the properties of the filaments can be substantially avoided.

The pressures at which the consumable-medium mixture is maintained while it acts on the toothbrush filaments or the corresponding wearing part may amount to between 5 bar and 300 bar, the preferred pressures being between 60 bar and 200 bar. According to a particularly advantageous embodiment of the invention, pressures of between 85 bar and 150 bar may be set.

The exposure period may last between a few minutes and several hours. Depending on the setting of the other process parameters, satisfactory results in terms of quantity, degree of penetration and uniformity of application of the substance can be produced already after an exposure period of 40 to 80 minutes.

The discontinuous application process is preferably a two-stage process. After the mixture of consumable and CO₂ is applied, the toothbrush filaments or the corresponding wearing part for personal needs are removed from the pressure vessel and passed to a rinse bath or an appropriate rinsing apparatus for a brief rinse, preferably of two to five minutes. Aside from the two immersion processes, once into the mixture of consumable and CO₂ and once into the rinse bath, no further process steps such as neutralization, deposit removal, etc. are necessary.

In particular the rinse process can be performed as a pure water rinse in the absence of any acids or neutralizers. On the one hand, this results in a gentler treatment, and on the other hand in a simplified process under safety and environmental aspects.

Conveniently, after expiration of the predetermined exposure period, the consumable-medium mixture is cooled and depressurized before the toothbrush filaments or the corresponding wearing part are removed.

The process parameters can be varied depending on the desired dyeing or penetration result. Advantageously, temperature, pressure and exposure period for the mixture of consumable and CO₂ may be calculated such that a penetration depth of around 1% to 30%, preferably of 5-25% of the radius of the toothbrush filaments, looking from outside, is reached.

The present method can be used for application of wear indicator dye to the filaments of a toothbrush, which dye wears off with increasing use of the toothbrush, a corresponding color change of the toothbrush filaments being thus indicative of their wear. Various dyes may generally be applied to the filaments. In a preferred embodiment of the invention, the dye Indigotine FD&C Blue No. 2, CAS-No. 860-22-0 may be used, which is dissolved in water to 0.005% to 0.5% and is impregnated with CO₂ under pressure. As an alternative to the dye referred to, other dyes such as FD&C Red No. 3, FD&C Yellow No. 6 or FD&C Green No. 3 may also be used.

Alternatively, water-insoluble dyes may be used which then result in permanent dyeing. According to a preferred embodiment of the invention, indigo carmine, azure, tetra blue, FD&C Blue No. 1, FD&C Blue No. 1 Al. Lake and phthalocyanine dyes such as phthalocyanine blue B may be used.

Aside from the application of dyes for wear indicating purposes, also other consumables such as flavorings, odorous substances and/or antibacterial agents and similar application substances which wear off in the course of use of the appliance may be applied to the toothbrush filaments or the corresponding wearing part for personal needs. For example, flavorings allowed for foodstuffs such as menthol, carvone, cinnamon or fruit flavorings may be applied as flavorings and/or odorous substances.

As antibacterial substances silver ion containing compounds such as silver-zinc zeolites as, for example, IRGAGUARD® types from Ciba Corporation (Tarrytown, N.Y.), or sanitized types from Clariant (Muttenz, Switzerland), may be applied to the toothbrush filaments or the corresponding wearing part for personal needs.

The method is particularly suitable for applying the above-described substances to toothbrush filaments made of plastics. The toothbrush filaments that may be used in the present method are in particular monofilaments of polymers as, for example, polyamide or nylon. In certain embodiments, filaments made of PA6/6, PA6/10 and/or PA6/12 may be utilized. The filaments used are advantageously extruded plastic threads which are stretched before being fixed. Preferably, filaments for toothbrushes may be dyed in a diameter range from 50 μm to 500 μm, in particular 100 μm to 250 μm.

It will be understood, however, that the application of the method is not limited to toothbrush filaments. Using the method, the consumables which wear off during use of the corresponding appliance can also be introduced into molded plastic parts in advantageous manner as, for example, by injection molding, whereby the respective substance is introduced temporarily and wears off gradually by use. This makes it possible, for example, to obtain an indicator function on the corresponding molded plastic part. Alternatively, this is an in particular soft elastic cleaning element manufactured, for example, from a thermoplastic elastomer. According to an advantageous embodiment of the invention, such a plastic molded part may be used in the head region or on the handle of a toothbrush. However, the present method may also be used for encoding other wearing products for personal needs with the appropriate consumable. Apart from products referred to as brush-ups or brush-aways, that is, elastic finger toothbrushes, it is also possible to use the present method for providing water filter change indicators, dental floss or electric replacement toothbrushes with the appropriate consumable.

Since no organic or inorganic acid (acetic acid, for example) is necessary for the methods described herein, application of the indicator is simplified. Furthermore, neutralization or intensive washing of the filaments is not necessary, and no salt deposits develop on the filament surface. Filament damage, including damage due to acid-induced swelling and shrinking of the filaments, can be avoided. Lower process temperatures and gentler treatment of the filaments simplify post-treatment and manufacturing steps, including endrounding of the filaments. Additionally, because complete hanks or spools can be dyed, the process is expedited considerably, and the problematic handling of separated filaments is avoided.

These and further features and advantages which, whether taken alone or in combination and sub-combination, form the subject-matter of the present description and may represent advantageous embodiments, will become apparent not only from the claims but also from the subsequent description of a preferred embodiment with reference to an accompanying drawing.

### DESCRIPTION OF THE DRAWING

FIG. 1 is a schematic flowchart of a two-stage, discontinuous dyeing process for toothbrush filaments wound onto a spool.

FIG. 2 depicts a dental care device.

### DETAILED DESCRIPTION

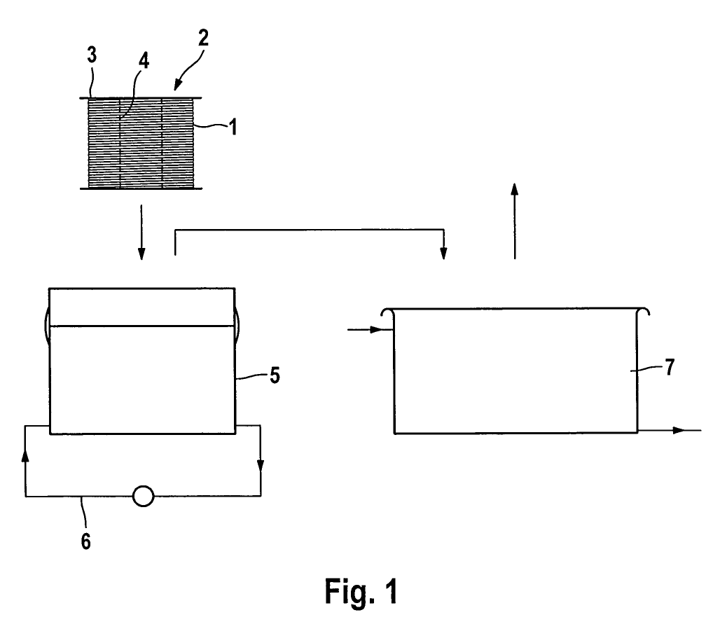

In the embodiment shown in FIG. 1, toothbrush filaments 1 which are wound onto a spool 2 are colored with a wear indicator dye. Wound onto the spool 2 are several tens of thousands of meters of filament, the body of the spool 2 being made of a permeable material. In particular the flanges or end walls 3 of the spool, i.e., the ends of the spool, and the spool core 4, are constructed to be permeable for the dye.

The filaments 1 used are extruded, stretched and fixed plastic threads of polyamide, in particular PA6/6, PA6/10 and/or PA6/12, with a diameter in the range from 50 μm to 500 μm. The filaments are preferably dyed without being softened, but depending on the softening basis, they may also be dyed with such softening. Softening is a post-treatment process involving coating of the filaments for improved handling, and can be on the basis of silicone or hydrocarbon.

In a pressure vessel 5 a dye bath is caused to circulate. The dye bath includes the dye Indigotine FD&C Blue No. 2, CAS-No. 860-22-0, dissolved in water to 0.005% to 0.5%, as well as CO₂ with which the dye solution is subjected to pressure. Using a suitable piping 6, the mixture of dye and CO₂ can circulate through the pressure vessel 5, thereby generating a forced flow in the pressure vessel.

When the dye bath is filled into the pressure vessel 5, the pressure vessel 5 and the piping 6 are heated to a desired temperature so that also the dye bath is heated to the desired temperature. The lid of the pressure vessel 5 is opened, and the spool 2 with the filaments 1 is immersed in the dye bath and fixed. The pressure vessel is closed and CO₂ is applied. Circulation is started, and when the predetermined dyeing temperature is reached, the filaments are dyed for a predetermined exposure period, followed by cooling and depressurization. The filament spool 2 can be removed from the pressure vessel 5 for transfer to a water bath 7 holding pure water to remove any residual dye. As FIG. 1 shows, the container of the water bath 7 may have an inflow and an outflow so that here, too, water flows through the container.

Concretely, the pressure vessel 5 and the dye bath contained therein may be heated to a temperature of between 60° C. and 120° C. The pressure is preferably set at between 60 bar and 200 bar, with the filaments 1 on the spool 2 being treated in the pressure vessel 5 for a period of between 40 and 80 minutes. The rinsing process in the water bath 7 is performed for preferably two to five minutes. The filaments 1 can subsequently be dried at room temperature. Owing to the circulation of CO₂ within and/or through the pressure vessel 5, it is possible for the filaments 1 wound onto the spool 2 to take the dye uniformly. As this occurs, the dye diffuses into the filaments from outside, with the degree of penetration depending on the condition of dyeing, so that different color intensities are obtainable. In order to obtain the desired indicator effect within the range of recommended toothbrush use, the degree of external penetration of the dye is preferably 1% to 30% of the radius of the individual filaments 1.

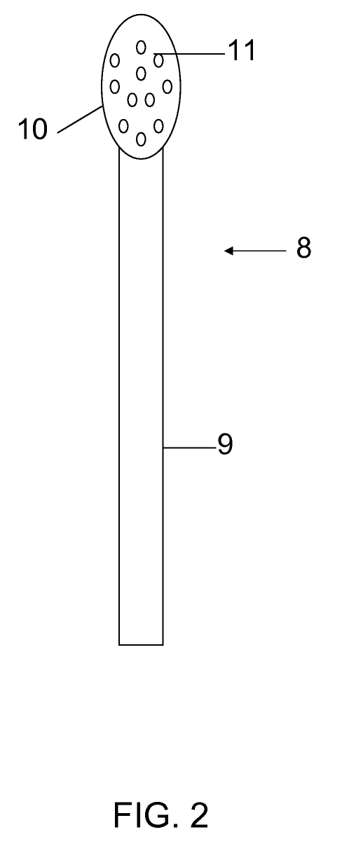

FIG. 2 depicts a dental care device 8. As shown in FIG. 2, dental care device 8 is a toothbrush. Dental care device 8 includes handle 9, bristle support 10, and toothbrush filaments 11.

1-27. (canceled)

28. A method of applying an indicator to an element of a dental care device, the method comprising:
(i) mixing the indicator with a fluid;
(ii) pressurizing the mixture to a pressure above atmospheric pressure; and
(iii) exposing the element to the pressurized mixture for a predetermined exposure period,
wherein the fluid comprises carbon dioxide, and wherein exposing the element to the pressurized mixture impregnates the indicator with carbon dioxide.

29. The method of claim 28, wherein the fluid consists essentially of carbon dioxide.

30. The method of claim 28, wherein the element comprises a plurality of toothbrush filaments.

31. The method of claim 30, wherein the plurality of toothbrush filaments is wound on a spool, and wherein a portion of the spool is permeable to the indicator.

32. The method of claim 28, wherein the indicator is a dye.

33. The method of claim 32, wherein the indicator is an indigotine dye.

34. The method of claim 28, wherein the indicator has a detectable odor or flavor.

35. The method of claim 28, wherein the indicator is antibacterial.

36. The method of claim 28, wherein the indicator is released from the element over time as a function of use.

37. The method of claim 28, further comprising forming an aqueous solution of the indicator.

38. The method of claim 37, wherein the aqueous solution comprises 0.005 wt % to 0.95 wt % indicator.

39. The method of claim 28, further comprising circulating the mixture in or through a container, wherein the circulating mixture is arranged to contact the element in the container.

40. The method of claim 39, wherein the container is a pressure vessel, and the element is exposed to the mixture in the pressure vessel in a discontinuous process.

41. The method of claim 28, further comprising applying pressure and/or temperature to elevate the fluid above its critical pressure and temperature.

42. The method of claim 28, further comprising heating the mixture to a temperature between room temperature and 140° C.

43. The method of claim 28, wherein the mixture is pressurized to a pressure between 5 bar and 300 bar.

44. The method of claim 28, wherein the element is exposed to the pressurized mixture for a length of time between 5 minutes and 5 hours.

45. The method of claim 28, further comprising adjusting a temperature or a pressure of the mixture to achieve a penetration depth of the mixture into the element of 0.5% to 15% of a dimension of the element.

46. The method of claim 28, further comprising adjusting a length of time of exposure of the element to the mixture to achieve a penetration depth of the mixture into the element of 0.5% to 15% of a dimension of the element.

47. The method of claim 28, further comprising cooling and depressurizing the mixture while the element is exposed to the pressurized mixture.

48. The method of claim 28, further comprising rinsing the element with water substantially free of acids and neutralizer after exposing the element to the pressurized mixture.

49. The method of claim 48, wherein rinsing the element with water comprises immersing the element in water.

50. The method of claim 28, wherein exposing the element to the pressurized mixture comprises immersing the element in the pressurized mixture.

51. A method of manufacturing a dental care device, the method comprising:
(i) applying a consumable indicator to a first component of the dental care device, wherein applying the indicator comprises:
(a) mixing the indicator with a fluid comprising carbon dioxide, such that the indicator is impregnated with carbon dioxide;
(b) pressurizing the mixture to a pressure above atmospheric pressure; and
(c) exposing the first component to the pressurized mixture; and
(ii) attaching the first component to a second component of the dental care device.

52. The method of claim 51, wherein the dental care device comprises a toothbrush.

53. The method of claim 51, wherein the first component comprises toothbrush filaments or a bristle support.

54. The method of claim 51, wherein the second component comprises a bristle support.

55. A dental care device comprising:
(i) a body;
(ii) an element coupled to the body, wherein the element is treated by a process comprising:
(a) mixing a consumable indicator with a fluid comprising carbon dioxide such that the indicator is impregnated with carbon dioxide;
(b) pressurizing the mixture to a pressure above atmospheric pressure; and
(c) exposing the element to the pressurized mixture.
